(19) United States
(12) Patent Application Publication
(10) Pub. No.: US 2026/0153061 A1
(43) Pub. Date: Jun. 4, 2026

(54) CYLINDER HEAD

(71) Applicant: TOYOTA JIDOSHA KABUSHIKI KAISHA, Toyota-shi (JP)

(72) Inventors: Naoya TAMURA, Toyota-shi (JP); Takahiro MATSUNAMI, Kani-shi (JP)

(73) Assignee: TOYOTA JIDOSHA KABUSHIKI KAISHA, Toyota-shi (JP)

(21) Appl. No.: 19/406,875

(22) Filed: Dec. 2, 2025

(30) Foreign Application Priority Data
Dec. 4, 2024 (JP) 2024-211652

(51) Int. Cl. F02F 1/40; F02F 1/42

(52) U.S. Cl. CPC F02F 1/40; F02F 1/4285

(57) ABSTRACT

A cylinder head includes a mounting hole that opens in a wall surface that defines a combustion chamber of the internal combustion engine and in which a spark plug of the internal combustion engine is mounted, an intake port and an exhaust port respectively provided on opposite sides with respect to the mounting hole, a first flow path for cooling water, which is connected to a water jacket in a cylinder block of the internal combustion engine at one side of the combustion chamber, is adjacent to the intake port, and extends toward the mounting hole along the wall surface, a second flow path for the cooling water, which is connected to the water jacket in the cylinder block at another side of the combustion chamber, is adjacent to the exhaust port, and extends toward the mounting hole along the wall surface, and a convex portion.

### CROSS-REFERENCE TO RELATED APPLICATION

This application is based upon and claims the benefit of priority of the prior Japanese Patent Application No. 2024-211652, filed on Dec. 4, 2024, the entire contents of which are incorporated herein by reference.

### TECHNICAL FIELD

The present disclosure relates to a cylinder head.

### BACKGROUND

Regarding a cylinder head of an internal combustion engine, for example, Japanese Unexamined Patent Application Publication No. H07-42612 describes that an embossed portion protruding from an upper portion of a flow path inner wall toward a combustion chamber downward is provided in a water jacket connected to a cooling water path on a cylinder block side in order to increase a flow velocity distribution of cooling water in the vicinity of the combustion chamber.

However, according to the above-described technique, the embossed portion might hinder the flow of the cooling water, and the pressure loss in the water jacket might increase.

### SUMMARY

It is therefore an object of the present disclosure to provide a cylinder head capable of improving cooling performance while suppressing an increase in pressure loss in a water jacket.

A cylinder head of an internal combustion engine of the present disclosure includes: a mounting hole that opens in a wall surface that defines a combustion chamber of the internal combustion engine and in which a spark plug of the internal combustion engine is mounted; an intake port and an exhaust port respectively provided on opposite sides with respect to the mounting hole; a first flow path for cooling water, which is connected to a water jacket in a cylinder block of the internal combustion engine at one side of the combustion chamber, is adjacent to the intake port, and extends toward the mounting hole along the wall surface; a second flow path for the cooling water, which is connected to the water jacket in the cylinder block at another side of the combustion chamber, is adjacent to the exhaust port, and extends toward the mounting hole along the wall surface; and a convex portion provided in at least one of the first flow path and the second flow path, wherein the convex portion protrudes in a direction inclined toward the combustion chamber with respect to a direction in which the at least one is adjacent to the corresponding one of the intake port and the exhaust port.

In the above cylinder head, the at least one may include a straight portion having a linear shape on an upstream side of the convex portion.

In the above cylinder head, the port adjacent to the at least one may be provided on an opposite side of the direction in which the convex portion protrudes.

In the above cylinder head, a surface of the convex portion may have a curved shape.

### BRIEF DESCRIPTION OF THE DRAWINGS

FIG. 1 is a partial cross-sectional view schematically illustrating an example of a configuration of an engine;

FIG. 2 is a cross-sectional view taken along line A-A of FIG. 1;

FIG. 3 is a cross-sectional view of a flow path of a cross section illustrated in FIG. 1, as viewed from an oblique direction;

FIG. 4 is a cross-sectional view taken along line B-B of FIG. 1; and

FIG. 5 is a view illustrating a flow of cooling water in the flow path.

### DETAILED DESCRIPTION

### Configuration of Engine

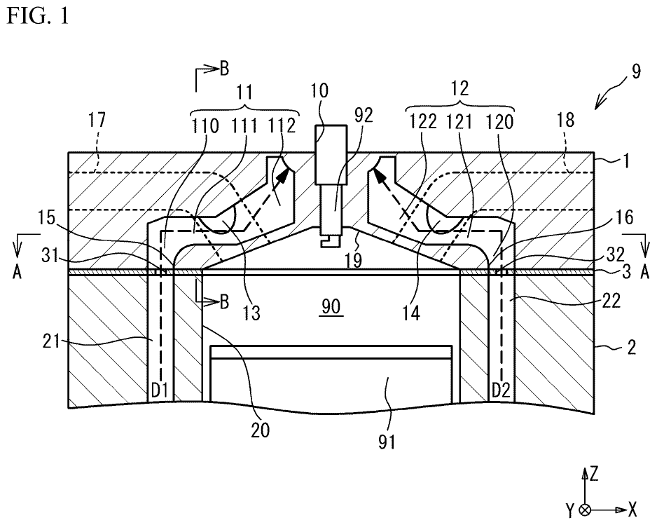

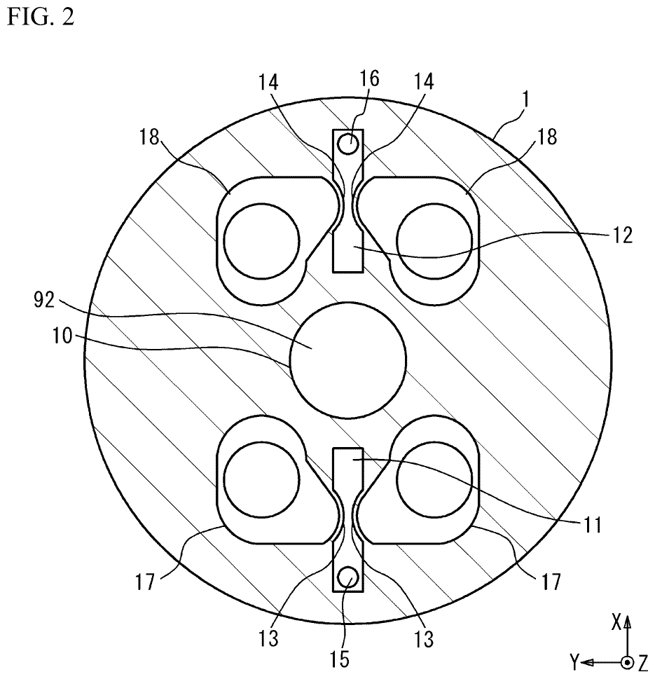

FIG. 1 is a partial cross-sectional view schematically illustrating an example of a configuration of an engine 9. FIG. 2 is a cross-sectional view taken along line A-A of FIG. 1. In FIGS. 1 to 5, an X direction, a Y direction, and a Z direction orthogonal to each other are illustrated.

The engine 9 is an example of an internal combustion engine mounted on a vehicle or the like, and is, for example, a gasoline engine or a diesel engine. The engine 9 includes a cylinder head 1 and a cylinder block 2 connected to each other via a gasket 3. FIG. 1 illustrates a partial cross section of the engine 9 along a connecting direction (Z direction) of the cylinder head 1 and the cylinder block 2.

The cylinder head 1 includes a mounting hole 10 for a spark plug 92, flow paths 11 and 12, for cooling water, of a part of the water jacket, an exhaust port 17 for exhaust, and an intake port 18 for intake. The mounting hole 10 extends toward the cylinder block 2 in the Z direction and opens in a wall surface 19 that defines a combustion chamber 90 of the engine 9. The spark plug 92 is inserted into the mounting hole 10 and mounted. The spark plug 92 ignites the mixture of the intake air and the fuel in the combustion chamber 90 in accordance with external control.

The combustion chamber 90 is defined by the wall surface 19 of a lower portion of the cylinder block 2, a cylinder 20 inside the cylinder block 2, and an upper surface of a piston that reciprocates in the Z direction inside the cylinder 20 when the air-fuel mixture is combusted. The mounting hole 10, the exhaust port 17, and the intake port 18 are opened in the wall surface 19 on the positive side (upper portion) in the Z direction of the combustion chamber 90. The intake port 18 introduces intake air from the outside into the combustion chamber 90, and the exhaust port 17 discharges exhaust gas from the combustion chamber 90 to the outside after combustion.

The two exhaust ports 17 and the two intake ports 18 are respectively provided on opposite sides with respect to the mounting hole 10. The two exhaust ports 17 and the two intake ports 18 are arranged at symmetrical positions with respect to the mounting hole 10 in a top view of the engine 9. The exhaust port 17 and the intake port 18 extend substantially linearly from the end portion of the cylinder head 1 in the X direction toward the center of the cylinder head 1, and are bent toward the combustion chamber 90 in the negative Z direction in the vicinity of the mounting hole 10.

The flow paths 11 and 12 for the cooling water is an example of first and second flow paths. The flow paths 11 and 12 and are provided on substantially the same straight line, and respectively provided on the opposite sides with respect to the mounting hole 10. The flow paths 11 and 12 is respectively adjacent to the exhaust port 17 and the intake port 18 in the Y direction, and extends toward the mounting hole 10 along the wall surface 19 of the combustion chamber 90. The flow paths 11 and 12 introduce the cooling water from introduction ports 15 and 16 opened on the cylinder block 2 side, respectively. The combustion chamber 90 is cooled by the cooling water flowing through the flow paths 11 and 12.

One of the flow paths 11 extends in the X direction between the two exhaust ports 17. The flow path 11 includes an introduction portion 110, a straight portion 111, and a lead-out portion 112. The introduction portion 110 extends in the Z direction and is connected to a water jacket 21 in the cylinder block 2 from the combustion chamber 90 side via an opening 31 of the gasket 3. The water jacket 21 extends in the Z direction and is adjacent to the cylinder 20 in the X direction. At an end of the introduction portion 110, the introduction port 15 is provided at a position corresponding to the opening 31.

The straight portion 111 is substantially orthogonal to the Z direction in which the water jacket 21 extends, communicates with the introduction portion 110, and extends linearly in the X direction. The lead-out portion 112 communicates with the straight portion 111 and extends obliquely (in the positive Z direction and the positive X direction) with respect to the straight portion 111 in front of the mounting hole 10. As indicated by an arrow D1, the cooling water is introduced from the cooling water jacket 21 into the introduction portion 110, and flows from the straight portion 111 to the other cylinders through the lead-out portion 112.

The other flow path 12 extends in the X direction between the two intake ports 18. The flow path 12 includes an introduction portion 120, a straight portion 121, and a lead-out portion 122. The introduction portion 120 extends in the Z direction and is connected to a water jacket 22 in the cylinder block 2 from the combustion chamber 90 side via an opening 32 of the gasket 3. The water jacket 22 is provided on the opposite side of the other water jacket 21 in the cylinder 20, extends in the Z direction, and is adjacent to the cylinder 20 in the X direction. At an end of the introduction portion 120, the introduction port 16 is provided at a position corresponding to the opening 32.

The straight portion 121 is substantially orthogonal to the Z direction in which the water jacket 22 extends, communicates with the introduction portion 120, and extends linearly in the X direction. The lead-out portion 122 communicates with the straight portion 121 and extends obliquely (in the positive Z direction and in the negative X direction) with respect to the straight portion 121 in front of the mounting hole 10. As indicated by an arrow D2, the cooling water is introduced from the water jacket 22 into the introduction portion 120, and flows from the straight portion 121 to the other cylinders through the lead-out portion 122.

The flow path 11 includes a convex portion 13 at the boundary between the straight portion 111 and the lead-out portion 112. The flow path 12 includes a convex portion 14 at the boundary between the straight portion 121 and the lead-out portion 122. The convex portion 13 projects in a direction inclined toward the combustion chamber 90 with respect to the direction in which the exhaust port 17 and the flow path 11 are adjacent to each other. The convex portion 14 projects in a direction inclined toward the combustion chamber 90 with respect to the direction in which the intake port 18 and the flow path 11 are adjacent to each other. Specifically, the convex portions 13 and 14 protrudes in a direction inclined to the negative side of the Z direction with respect to the Y direction. Further, the exhaust port 17 and the intake port 18 are provided on the back side of the convex portions 13 and 14 in the Y direction. The shape of the convex portions 13 and 14 will be described below.

### Shape of Convex Portion

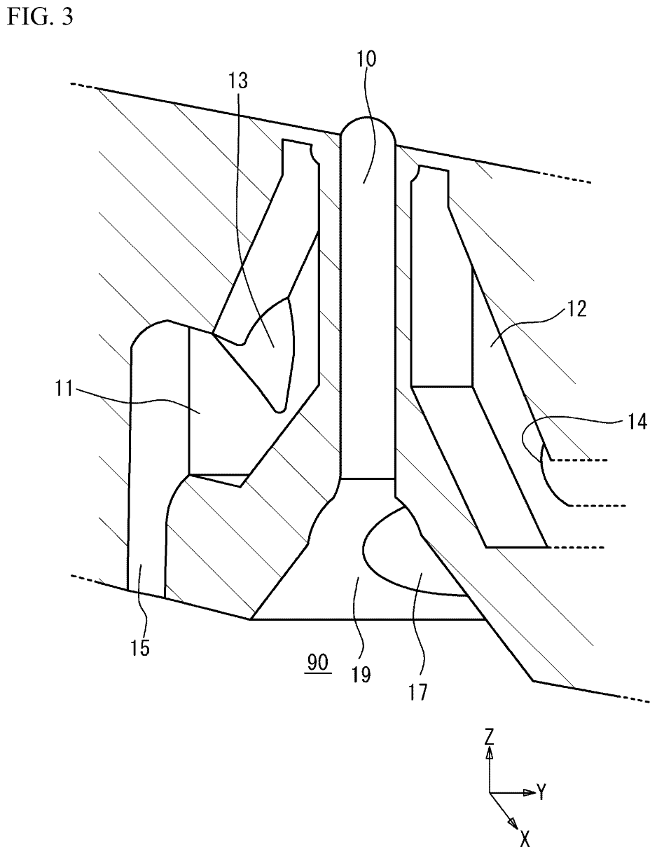

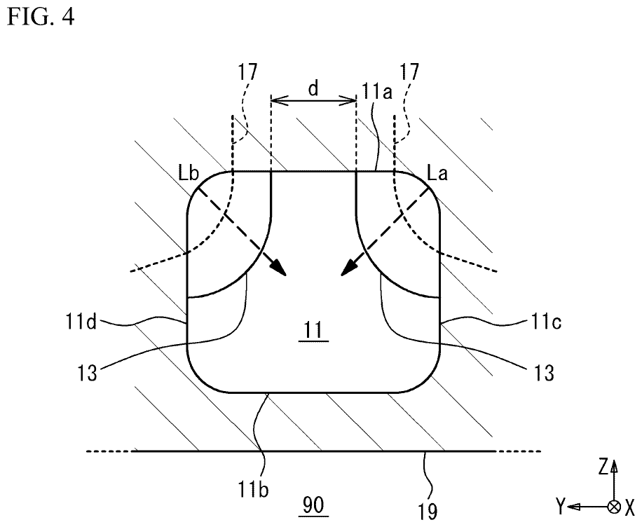

FIG. 3 is a cross-sectional view of the flow path 11 of the cross section illustrated in FIG. 1, as viewed from an oblique direction. FIG. 4 is a cross-sectional view taken along line B-B of FIG. 1. FIG. 3 illustrates a cross section of FIG. 1 from a viewpoint inclined to the positive side in the X direction with respect to the Y direction. FIG. 4 illustrates a cross section of the flow path 11 in the vicinity of the convex portion 13. In this example, the flow path 11 and the convex portion 13 are illustrated, but the shapes of the flow path 12 and the convex portion 14 are the same as the convex portion 13.

The cross section of the flow path 11 is, for example, substantially rectangular. Regarding two surfaces facing each other in the Z direction, the surface on the positive side in the Z direction is referred to as an upper surface 11a, and the surface on the negative side in the Z direction is referred to as a lower surface 11b. Of the two surfaces facing each other in the Y direction, the surface on the positive side in the Y direction is referred to as a side surface 11d, and the surface on the negative side in the Y direction is referred to as a side surface 11c.

The flow path 11 is provided with a pair of the convex portions 13 facing each other in the Y direction. One of the convex portions 13 protrudes from the upper surface 11a and the side surface 11c in the protruding direction La. The other convex portion 13 protrudes from the upper surface 11a and the side surface 11d in the protruding direction Lb. The protruding directions La and Lb are directions inclined toward the combustion chamber 90 (in the negative Z direction) with respect to the Y direction in which the exhaust port 17 and the flow path 11 are adjacent to each other.

In this way, the convex portions 13 protrude from two corner portions on the positive side in the Z direction toward the combustion chamber 90 in the cross section of the flow path 11. Therefore, the main flow of the cooling water is guided to a region close to the combustion chamber 90, and the combustion chamber 90 is cooled more effectively than in the case where the convex portion 13 is not provided. In the cross section of the flow path 11, the convex portion 13 obliquely projects with respect to the combustion chamber 90, and the cooling water flowing from the cylinder block 2 easily flows to the upper surface 11a side, as compared with a case where the convex portion 13 protrudes from the upper surface 11a toward the combustion chamber 90 (in the negative Z direction). Therefore, the resistance acting on the cooling water is reduced. In the upper surface 11a, a space d is secured between the pair of the convex portions 13 so as to further reduce resistance to the cooling water, but the space d is not necessarily required.

The surface of the convex portion 13 has a curved shape. For example, the convex portion 13 bulges from the corner between the upper surface 11a and the side surfaces 11c or 11d toward the combustion chamber 90. Therefore, the resistance to the cooling water is further reduced as compared with the case where the surface of the convex portion 13 has a planar shape. The surface of the convex portion 13 is not limited thereto, and may be a planar shape.

The intake port 18 is provided on the opposite side of the convex portion 13 in the protruding directions La and Lb in which the convex portions 13 respectively protrude. Therefore, the larger the volume of the convex portion 13 is, the more the size of the exhaust port 17 is expanded. This increases the exhaust amount of the exhaust port 17. Further, the intake port 18 may be provided on the opposite side of the convex portion 14 of the other flow path 12, and in this case, the intake amount of the intake port 18 increases. The exhaust port 17 and the intake port 18 are not limited to this, and may not be provided on the opposite side of the convex portions 13 and 14.

### Flow of Cooling Water

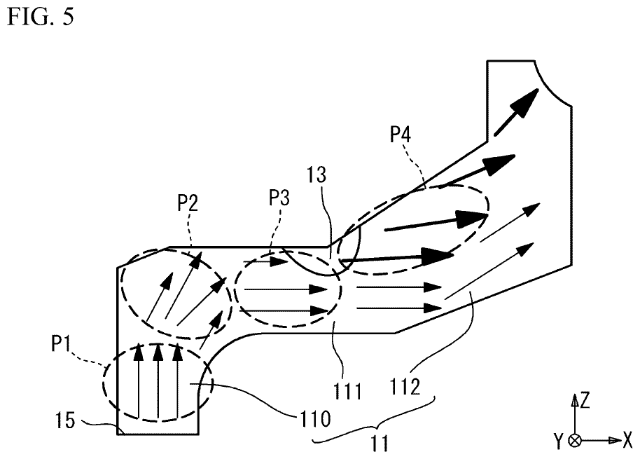

FIG. 5 is a view illustrating the flow of the cooling water in the flow path 11. FIG. 5 illustrates the shape of one of the flow paths 11 in FIG. 1, and the direction and thickness of the arrows in the flow path 11 schematically indicate the direction and speed of the flow of the cooling water. The flow of the cooling water is a result of a simulation performed by the inventors.

In the vicinity of the introduction port 15 of the introduction portion 110, the cooling water introduced from the water jacket 21 on the cylinder block 2 side flows to the positive side in the Z direction, as indicated by reference sign P1. In the vicinity of the boundary between the introduction portion 110 and the straight portion 111, as indicated by reference sign P2, the cooling water hits the upper surface of the flow path 11, and thus the flow direction is dispersed.

However, since the straight portion 111 is formed in a linear shape, the direction of the flow of the cooling water is aligned in the region on the downstream side of the straight portion 111 as indicated by the reference sign P3. On the downstream side of the convex portion 13, as indicated by reference sign P4, the fast mainstream (see the thick arrow) flows not in a region along the upper surface but in a region closer to the combustion chamber 90 than the upper surface. Therefore, the combustion chamber 90 is effectively cooled.

In the present example, since the straight portion 111 is provided on the upstream side of the convex portion 13, the direction of the flow of the cooling water that has been dispersed once is aligned, and therefore, the flow of the cooling water by the convex portion 13 is effectively controlled as compared with the case where the straight portion 111 is not provided. The straight portion 111 is not necessarily provided. In addition, although the present embodiment has been described by taking the one flow path 11 as an example, the same operation and effect as described above is obtained also in the other flow path 12.

In the above-described embodiment, the convex portions 13 and 14 is provided in both of the two flow paths 11,12, but the convex portions 13 and 14 may be provided in at least one of the flow paths 11 and 12.

Although some embodiments of the present disclosure have been described in detail, the present disclosure is not limited to the specific embodiments but may be varied or changed within the scope of the present disclosure as claimed.

What is claimed is:

1. A cylinder head of an internal combustion engine, comprising:
a mounting hole that opens in a wall surface that defines a combustion chamber of the internal combustion engine and in which a spark plug of the internal combustion engine is mounted;
an intake port and an exhaust port respectively provided on opposite sides with respect to the mounting hole;
a first flow path for cooling water, which is connected to a water jacket in a cylinder block of the internal combustion engine at one side of the combustion chamber, is adjacent to the intake port, and extends toward the mounting hole along the wall surface;
a second flow path for the cooling water, which is connected to the water jacket in the cylinder block at another side of the combustion chamber, is adjacent to the exhaust port, and extends toward the mounting hole along the wall surface; and
a convex portion provided in at least one of the first flow path and the second flow path,
wherein the convex portion protrudes in a direction inclined toward the combustion chamber with respect to a direction in which the at least one is adjacent to the corresponding one of the intake port and the exhaust port.

2. The cylinder head according to claim 1, wherein the at least one includes a straight portion having a linear shape on an upstream side of the convex portion.

3. The cylinder head according to claim 1, wherein the port adjacent to the at least one is provided on an opposite side of the direction in which the convex portion protrudes.

4. The cylinder head according to claim 1, wherein a surface of the convex portion has a curved shape.
